(19) United States
(12) Patent Application Publication
(10) Pub. No.: US 2009/0097634 A1
(43) Pub. Date: Apr. 16, 2009

(54) Method and System for Call Processing

(76) Inventors: Ullas Balan Nambiar, New Delhi (IN); Himanshu Gupta, Etah (IN); Mukesh Kumar Mohania, New Delhi (IN); Amitabh Ojha, New Delhi (IN)

Correspondence Address: FREDERICK W. GIBB, III;Gibb Intellectual Property Law Firm, LLC, 2568-A RIVA ROAD, SUITE 304, ANNAPOLIS, MD, 21401, US

(21) Appl. No.: 11/872,881

(22) Filed: Oct. 16, 2007

(51) Int. Cl. H04M 3/00

(52) U.S. Cl. 379/265.09

(57) ABSTRACT

A method and system for call processing to assist call center agents at a call center, where a call in the form of an unstructured voice signal is received from a caller at the call center, the received call is transcribed into readable text data, and keywords are identified in the readable text data to determine a context for the voice signal based on the identified keywords, based on the context identifying and extracting matching entities from a data store, and presenting the extracted entities and possible new queries to the call center agent based on the set of most relevant entities.

### BACKGROUND OF THE INVENTION

1. Technical Field

The present invention relates to a call processing system and more particularly to call center and call centre applications for processing unstructured voice data.

2. Description of the Related Art

A call centre can be defined as a place in a company or business that handles incoming and/or outgoing calls from/to its customers in support of its day-to-day operation. This can be a telemarketing area, where the employees make outgoing calls to try and sell the company's products. It can be a service area that receives incoming calls from its customers for repair or maintenance of the company's goods or services. A call centre will have a telephone system which may be as simple as a small single-line phone, increasing in complexity up to a large multi-node PBX. A call centre would normally have a computerized system for tracking, logging and recording call details, although some simply use paper forms. It may have one operator or agent, or it may have many, depending on the size of the company or business.

A call-center is typically used wherever a large number of calls must be handled for some common enterprise. Typically, the calls of the enterprise are routed through the call-center as a means of processing the calls under a common format. Call-centers typically include at least three elements: an automatic call distributor (ACD), a group of agents for handling the calls, and a host computer containing customer information. The individual agents of the groups of agents are each typically provided with a telephone console and a computer terminal. The telephone terminal receives customer calls distributed to the agent by the ACD. The terminal may be used to retrieve customer records from the host and store such information in a database.

Currently, when a caller (hereinafter referred to also as a client or a customer) is connected to a call center agent (hereinafter also referred to as an agent), only limited information about the purpose of the call is available to the agent. Callers to call centers typically spend a considerable amount of time on hold, while waiting to talk to a call center agent. Currently some call center systems may prompt the caller for specific information while the caller is waiting to talk to an agent. The caller may be asked to enter the information by various available means, for example touch-tone response or by voice, which would be then interpreted by an automatic speech recognition system. While this is a step in the right direction, this conventional approach allows only structured information entry. In other words, the user's response is made with respect to a particular question or topic that the call center system knows about in advance. There is therefore, no effective way of accepting and using unstructured voice responses from the caller.

A call centre needs to ensure quality control on their agents performance in an interaction with a caller in order to maintain a high level of customer satisfaction and to keep an acceptable call rate through each agent. While call centers are effective, the skill level of agents varies considerably. To simplify and add consistency to call handling, agents are often provided with written scripts to follow during conversations with customers. While such scripts help, they may prove ineffective in the case of a customer who asks questions or otherwise does not allow the agent to follow the prepared script. Accordingly, a need exists for a way of making presentations to the customer that is not limited to a predetermined format. Without a way to provide an improved method and system of assisting agents in a call centre, the promise of this technology may never be fully achieved

### SUMMARY

A method and system for assisting agents in a call center, preferably for preference elicitation, i.e., asking queries to determine preferences is a key function performed by call center agents. This invention provides a domain independent method for helping call-center agents in preference elicitation. A speech recognition system translates the real-time audio conversation, when a call is received by an agent from a customer, into text, and then identify the best set of objects, for example database records, documents, emails etc; thereby being able to capture the context of the conversation. These objects are displayed to the agent in real-time while the conversation is still on with the customer. This assists the agent by suggesting new queries that are determined based on the objects that have been mapped to the on-going conversation and based on a particular context, thereby providing the agent to quickly learn the interests of the customer and provide the best response.

Disclosed is a method and system for call processing to assist call center agents at a call center, where a call in the form of an unstructured voice signal is received from a caller at the call center, the received call is transcribed into readable text data, and keywords are identified in the readable text data to determine a context for the voice signal, based on the context identifying and extracting matching entities from a data store, and presenting the extracted entities to the call center agent which are a set of most relevant entities.

In a further embodiment, transcribing the unstructured voice signal consists of segmenting the unstructured voice signal into a sequence of terms or keywords, where a keyword may means a single word or a group of words that form a phrase, and filtering those terms or keywords that are not relevant to the context, retaining only those terms or keywords that are relevant. In a further embodiment, the repository may be a structured or unstructured database containing entities including information selected from a group consisting of relational data, tabular data, audio/video data, and graphical data. Other embodiments are also disclosed.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 illustrates an exemplary embodiment of a call center where embodiments of the present invention may be implemented.

FIG. 1A illustrates an exemplary embodiment of a system in accordance with the present invention.

FIG. 2 illustrates an exemplary embodiment of a transcription output as an XML file, in one embodiment of the invention.

FIG. 3 illustrates an exemplary embodiment of method for generating preference elicitation in accordance with the present invention.

FIG. 4 illustrates an exemplary embodiment of the process in accordance with the present invention.

### DETAILED DESCRIPTION

The following is intended to provide a detailed description of an example of the invention and should not be taken to be limiting of the invention itself. Rather, any number of variations may fall within the scope of the invention, which is defined in the claims following the description.

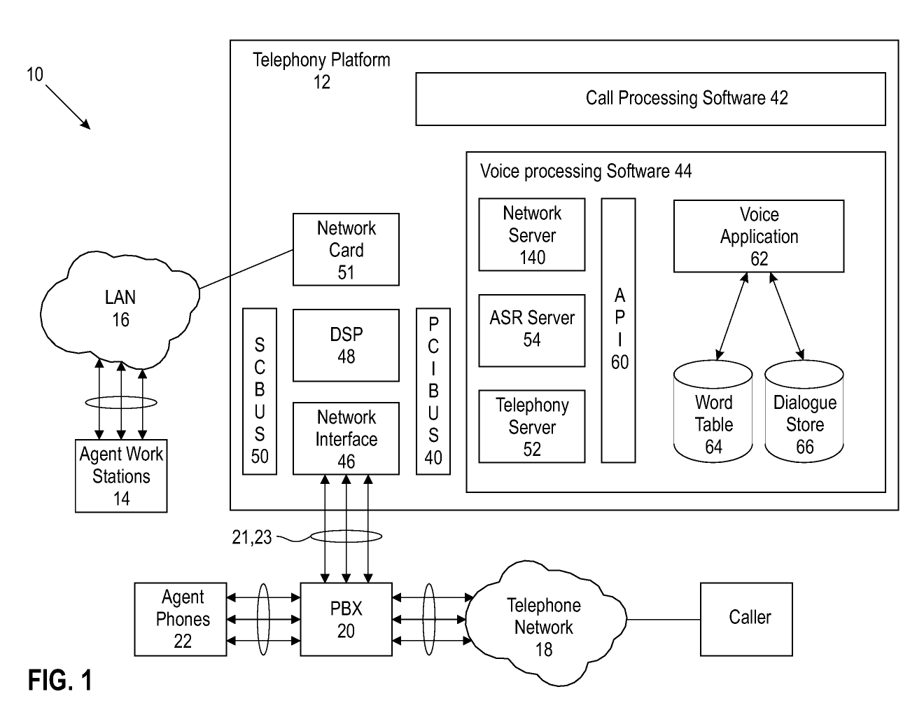

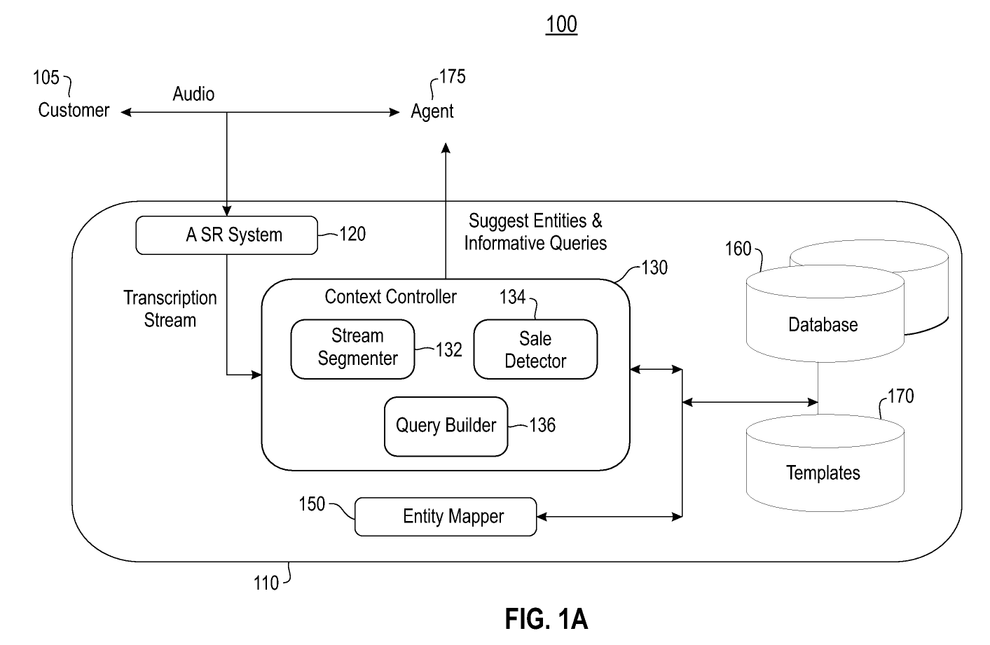

Referring to FIG. 1 a call centre 10 comprises: a PC based computer telephony platform 12; a number of PC based computer clients or agent workstations 14 connected to the telephony platform 12; a local area network (LAN) 16 connecting the workstations 14 and the telephony platform 12; a telephony switch (PBX) 20; a control line 21 connecting the telephony platform 12 with the switch 20; telephone lines 23 connecting the telephony platform 12 with switch 20; agent telephones 22 corresponding to each of the workstations 14 connected to the switch 20. Additional telephone lines connect switch 20 to public telephony network 18 and switch 20 to agent phones 22.

The switch 20 makes, breaks or changes the connections between telephone lines in order to establish, terminate, or change a telephone call path; it is typically a private branch 5 switch residing on the same premises as the telephony platform 12. The switch 20 would suitably be a Siemens Hicom 300 but could be one of many suitable switches provided amongst others by Lucent, Nortel or Alcatel. The switch 20 provides network information to the telephony :o application such as ANI (answer number identification, also known as Caller Line Identification (CLI)) and DNI (dialed number identification). It also allows telephony platform 12 to perform intelligent dialing functions and to transfer calls.

Each workstation 14 is typically a Pentium microprocessor based PC with 32M bytes of memory, 4 Gbytes of hard drive, keyboard, mouse and VDU connected to the LAN 16 using an Ethernet card. A suitable operating system is Microsoft NT for workstations running the workstation application. The workstation application sends and receives messages from the switch through the LAN 16 and telephony application using an application programming inter-face which is part of the telephony application.

Telephony platform 12 comprises: a personal computer with an Industry Standard Architecture (ISA) bus or a Peripheral Component Interconnect (PCI) bus 40, running Microsoft Windows NT; call processing software 42; voice processing software 44; one or more Dialogic or Aculab network interface cards 46 for connecting the required type and number of external telephone lines 23; one or more Dialogic voice processing cards 48; a System Computing Bus (SCbus) 50; and LAN network interface 51. SCbus 50 is a dedicated voice data bus which connects the network card 46 and the DSP card 48 so that data flow congestion on the PCI system bus is avoided and voice processing speed is increased. Telephony platform 12 supports up to 60 E1 or 48 T1 telephone lines 23 connected through telephony network interface 46. If call volumes require more than 60 E1 or 48 T1 lines, additional voice processing systems can be connected together through the LAN 16.

Call processing software is suitably based on IBM Call-Path software for controlling the interactions between the agent workstations and agent telephones. The voice processing software 44 comprises IBM's Voice 45 Response for Windows (previously known as IBM DirectTalk/2) is a powerful, flexible, yet cost-effective voice-processing software for the Windows NT operating system environment. Although the embodiment is described for Windows, an equivalent platform is also available for the 50 UNIX environment from the IBM Corporation, in which case a maximum of 12 digital trunks per system (360 E1 or 288 T1 channels) may be supported. Used in conjunction with voice processing hardware, Voice Response can connect to a Public Telephone Network directly or via a PBX. 55 It is designed to meet the need for a fully automated, versatile, computer telephony system. Voice Response for Windows NT not only helps develop voice applications, but also provides a wealth of facilities to help run and manage them. Voice Response can be expanded into a networked gQ system with centralized system management, and it also provides an open architecture, allowing customization and expansion of the system at both the application and the system level.

The voice processing software 44 comprises: a telephony 65 server 52; an automatic speech recognition (ASR) server 54; a natural language understanding (NLU) server (not shown); a dialogue manager (DM) server (not shown); a development work area (not shown); an application manager (not shown); a node manager (not shown); a general application programming interface (API) 60; voice application 62; word table 64; and dialogue store 66. API 60 is a conduit for all communications between the component parts of the voice processing software 44. A server is a program that provides services to the voice response application 62 or any other client. The modular structure of the voice processing software 44 and the open architecture of the general server interface API 60 allows development of servers that are unique to specific applications. A user-defined server can provide a bridge between the voice processing software and another product.

Telephony server 52 connects to the network interface 46 and provides telephony functionality to the voice response application. The automatic speech recognition (ASR) server 54 is large-vocabulary, speaker-independent continuous function based on IBM Via Voice and using DSP 48 to perform the preliminary frequency analysis on the voice signal. The voice signal is converted into frequency coefficients by the DSP 48 which are passed on to the ASR server 54 to perform Markov analysis and phoneme matching to acquire machine-readable text.

The development work area allows the creation and modification of a voice-processing application. The application manager executes the voice response application. The node manager allows monitoring of the status of application sessions and telephone lines and allows the issue of commands to start and stop application sessions.

Voice application 62 controls the interaction between the voice processing software 44 and a caller. Applications are written in Telephony Java, which incorporates the power and ease-of-use of the Java programming language. The voice processing system can run up to sixty applications simultaneously ranging from one voice response application running on all sixty lines to sixty different voice applications 62 each running on a separate line. In accordance with one embodiment of the invention, the callers device can include devices a range of devices from a desktop computer, laptop computer, Personal Digital Assistants, Mobile Phones etc, wherein the caller may be using a direct PTSN line or the call may be placed over a Voice over Internet Protocol (VoIP) network.

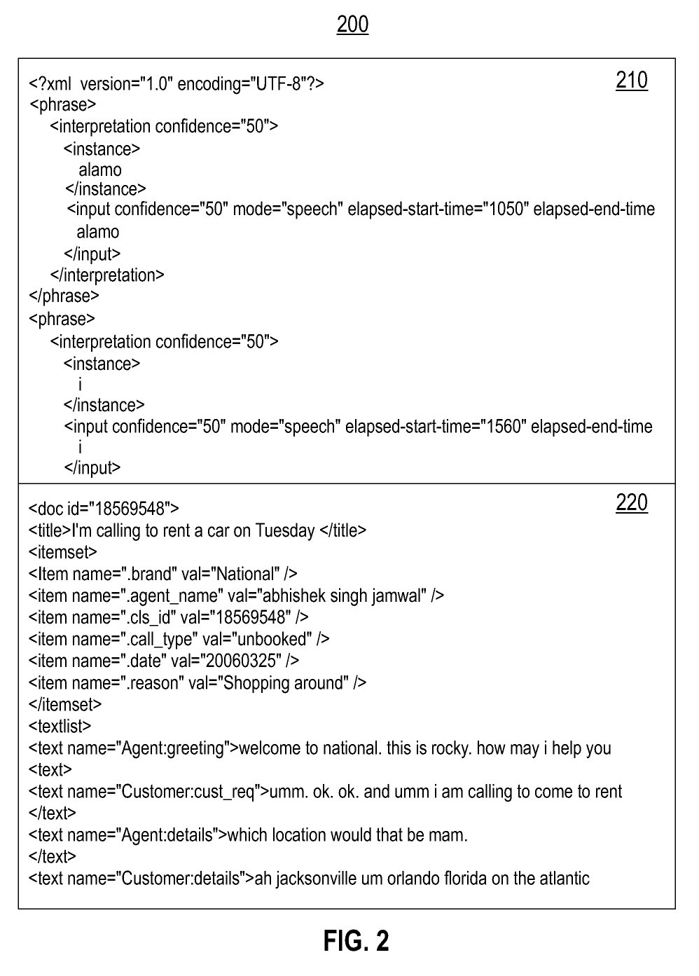

The architecture of a system in accordance with the present invention and the flow of information through the system 100 are illustrated in FIG. 1A. The system comprises a module 110 which is configured to receive the unstructured voice input from a caller 105 which has been routed to the call centre agent 175. The call is routed via a module 110 which consists of an Automatic Speech Recognition (ASR) system 120, coupled to a context controller 130, an entity mapper 150 and a data store 160 (which is hereinafter also referred to as a repository or database). The repository 160 is further coupled to a store of templates 170, which may be part of the same repository 160 in one embodiment. The ASR is configured to process the unstructured voice signal and pass on the contents of the voice signal to context controller 130, which interacts with a repository 160 to provide the call center agent 175 with suggestive entities and information queries which are relevant to a context and determined to be the best possible and available entities or queries. In one embodiment, additionally, the context controller 130 consists of the stream segmenter (SS) 132, sale detector (SD) 134 and query builder (QB) 136. It should be obvious to a person skilled in the art that various other implementations modifications can be made to be architecture of FIG. 2 without departing from the scope of this invention, configured to perform the functionality of providing the call center agent 175 with suggestive entities and information queries based on a particular context. It should also be obvious to a person skilled in the art that to avoid any error in classification, a simple (single-level) IVR (Interactive Voice Response) system is used as the first step in the conversation, and that IVR's are already used by most call centers to direct the customer to an agent, and based on the IVR input, the call can be classified into new customer, tracking past order, filing complaint etc. and also identify the entity-template to be used for processing the incoming call.

Typically, two types of inputs are necessary for the module 110, namely a streaming transcript of an unstructured voice signal (hereinafter also referred to as a audio call) in progress and entities stored in a database 160. ASR 120 that are available can be used for transcribing the input speech data arriving via the audio call from the customer 105. In one embodiment, consider a single channel 6 KHz speech (which is an agent and caller mixed) input is fed to the ASR 120 and the resulting output from is streamed to an entity mapper 150 via the context controller 130. The output generated is typically noisy due to the inaccuracy or inconsistencies of the ASR 120. Typically, ASR systems have 60-70% accuracy in transcribing telephonic conversations (in this case the audio call from the customer). The transcription output in one embodiment can be an XML file as shown in FIG. 2, which includes the transcript and some meta-data; for example, each word has time-stamps of its beginning and end as illustrates in the top half 210 of FIG. 2. The raw transcription output can be sanitized by passing it through annotators such as those known to a person skilled in the art. For example, in one embodiment the following tool can be used, D. Ferrucci and A. Lally. UIMA: an architectural approach to unstructured information processing in the corporate research environment. Natural Language Engineering, 10(3):4769-489, 2004. Such annotators can add additional knowledge to the transcript by adding call related metadata, identifying sentence boundaries and call segments. The bottom-half 220 of FIG. 2 illustrates such a processed transcript. In this invention however, availability of a raw transcript as output from the ASR system 120 is assumed.

The task of SS 132 is to buffer the streaming output generated by the ASR system 120. The buffer when full is passed on to the entity mapper 150 as a segment of the conversation for which relevant entities have to be identified. Only words uttered/spoken by the customer 105 or agent 175 is considered as being part of the stream buffer. All meta-data such as utterance duration, speaker id etc is stripped from the transcript by SS 132. The size of the buffer used by SS 132 is decided by the stream segmentation heuristic in place. In the absence of meta-information about the stream, an effective approach is to use a fixed buffer size. It should be obvious to a person skilled in the art that various other alternate approaches would also be to detect a change in speaker and use that to push the buffer contents forward. However, the approach in accordance with the present invention would isolate parts of conversation that may be closely related and could be helpful in determining the context. Segmenting the conversation into pre-specified parts such as greetings, query, resolution etc and use the segment boundaries as window boundaries would be preferable according to the present invention, and it would necessitate additional processing over the raw transcript, and would also introduce errors brought forth by the segmentation engine. Hence, with an objective to minimizing errors a fixed window length approach is preferably used in accordance with this invention.

The entity template 170 specifies (a) the entities to be matched in the document and (b) for each entity, the context information that can be exploited to perform the match. In one embodiment, the entity template 170 is a rooted tree with a designated root node. Each node in this tree is labeled with a table in the given relational database schema, and there exists an edge in the tree only if the tables labeling the nodes at the two ends of the edge have a foreign-key relationship in the database schema. The table that labels the root node is called the pivot table of the entity template, and the tables that label the other nodes are called the context tables. Each row e in the pivot table is identified as an entity belonging to the template, with the associated context information consisting of the rows in the context tables that have a path to row e in the pivot table through one or more foreign-keys covered by the edges in the entity template.

The entities are extracted based on the entity template associated with the audio call given as input from the caller 105. Dynamically detecting the template to use is a non-trivial problem. In accordance with the present invention, a primary template and secondary templates are associated to every type of call received by the call center agent 175. The entities to be mapped to the conversation will be extracted using the primary template, while other opportunities can be identified from the secondary templates. In accordance with the present invention all secondary entities (those obtained from secondary templates) are equally relevant which can be dynamically identified.

The secondary templates and rules mapping them to the primary template are loaded into the SD 134 once a primary template is identified. Rules that associate which secondary template are to be invoked when a subset of the primary template is bound can be assigned manually or automatically by the system. Using such rules, the SD 134 will invoke a separate entity mapper process which would receive the corresponding secondary template as the primary template from which to extract entities. The extracted entities would be shown as potential opportunities and/or relevant additional information to the agent 175.

The output from SS 132 a subset of the audio conversation that has been buffered; is sent to entity mapper 150 as the unstructured text to which entities have to mapped. The entities are defined by the primary template which is also given as input. The entity mapper 150 performs the mapping, where any inaccuracy introduced by ASR system 120 is addressed and answers are provided in real-time. Once the best matching entities are identified, entity mapper 150 returns the best set of relevant entities to the context controller 130, which are then provided to the agent 175. Given the limited space available on the agent's desktop, only the most relevant parts of an entity are displayed to the agent. The information (set of attributes) displayed must explain why the given set of entities were chosen from all the entities available.

The process of extracting relevant entities based on the transcript given to entity mapper 150. Even though the actual conversation is made up of a number of sentences, for the purpose of detecting the entities, it to considered to be a single sentence S, that keeps growing when new input is received from the Context Controller 130. The above assumption significantly reduces the amount of time involved in detecting the best mapping by removing the iterative prefix (subset of S) computation and corresponding best mapping extraction. The reduction in time is important given the need for real-time response from system 100. Another time saving measure we use is to filter out unimportant terms (words) appearing in the transcript. Under the assumption that nouns are more likely to appear as binding values in a database, parts-of-speech are parsed to identify and retain only noun-phrases. Only the retained terms are used in the mapping.

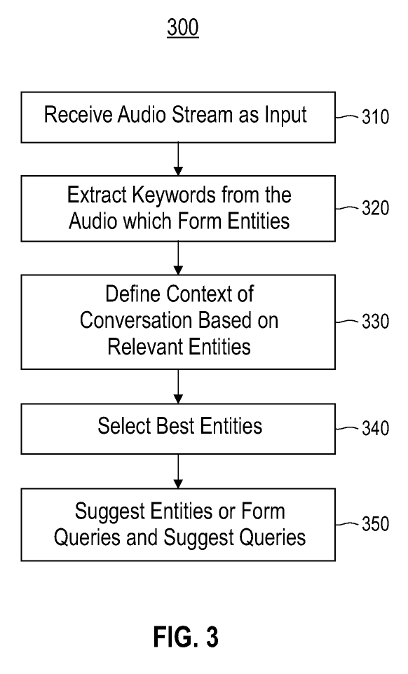

FIG. 3 illustrates an exemplary embodiment of method for generating preference elicitation in accordance with the present invention. The method 300 is an approach for identifying context defining queries which can be identified during a continuously streaming audio input stream. As defined earlier, this audio input could comprise unstructured data. In step 310, an input audio stream established between the caller and the call centre agent is received. Given a streaming conversation (audio input) S and a relational database R whose entity is preferably being described by the conversation, in step 320 keywords are extracted that can be used to extract possible candidate entities. The method in accordance with the present invention is advantageously used to define the context of the conversation in terms of relevant entities in Step 330, where the relevant entities (or set of relevant entities) Eₜ, that map to the conversation. In step 340, a single best entity, \tilde{e}, for every conversation, is identified. The set of entities Eₜ can be seen as a partial definition of \tilde{e}. In a preferred embodiment a set of best entities may be selected. In step 350, the best entity or entities are suggested to the call centre agent, and preferably in one embodiment, the entities are used to form a query and the query Q is suggested to the call centre agent.

Essentially, this amounts to identifying the attribute that can classify Eₜ, into the largest number of disjoint subsets. This information can be advantageously used as the measure to decide the attribute over which to formulate the query. Picking attributes such as transaction ids, invoice numbers, etc., is avoided which would have large number of distinct values but would be difficult for the caller to provide. The task performed is equivalent to identifying the attribute that might appear at the top of a decision tree built over Eₜ. Building the complete tree helps in identifying a sequence of queries that when asked in order could identify a single entity belonging to Eₜ. However, for a certain Eₜ it cannot be guaranteed that \tilde{e} is present in Eₜ since it is not based on the complete conversation. Therefore, building the complete decision tree and asking a series of queries may often lead to in-optimal use of time. Hence, in the current implementation we identify a single query for each distinct Eₜ.

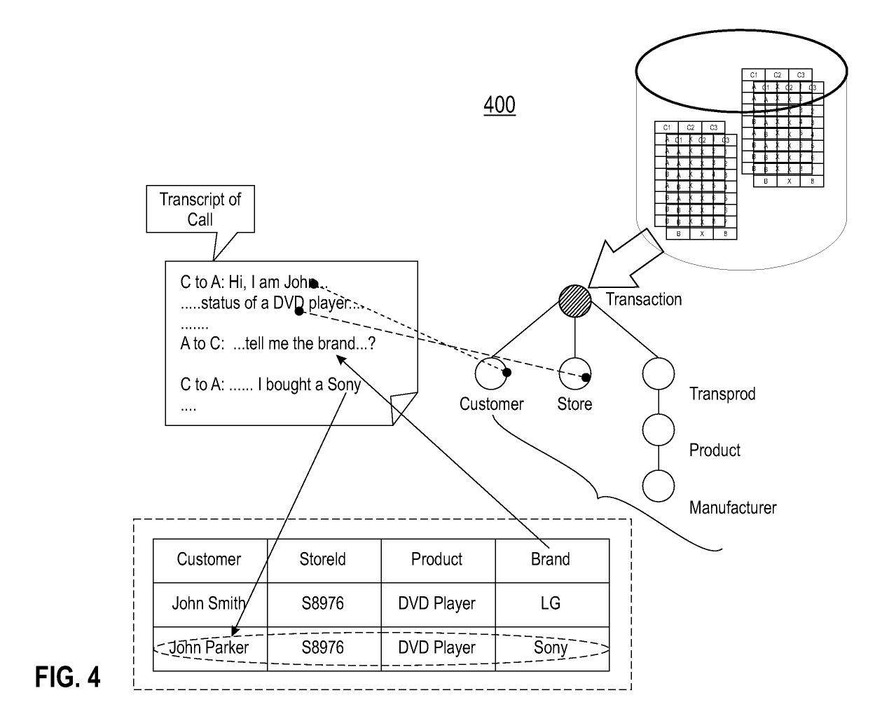

FIG. 4 illustrates an exemplary embodiment of the process in accordance with the present invention. The input to our system is a streaming transcript (readable text automatically generated in real-time from the audio) of the conversation. The conversation starts with customer/caller (C) telling agent (A) that the caller (in the example referred to as John) wants to enquire about the DVD player purchased by the caller from the store. Terms that might appear in a transaction (a record typically stored in a database) are of interest and since most attributes (features) appearing in such records are bound (filled) using noun phrases, noun phrases are selected as keywords.

Accordingly, John and DVD player are selected as keywords. Since the context defined by the terms John and DVD Player is quite broad, several transactions will be relevant to the conversation by way of having one of these terms in their context. To narrow the list, easy to answer yet highly classifying queries are formulated based on the extracted set. Accordingly the agent is prompted to ask for the brand of the DVD player. The prompt is shown by the column being highlighted in bold in FIG. 4. The customer then provides the brand of the DVD player and this allows the system to narrow down to the correct record. This will help the agent to narrow the context of a conversation by suggesting relevant queries in (near) real time and thereby help reduce the average response time for a call. Another advantage of the present system is the reduction in agent training time, a major cost factor when inducting a new agent or relocating agent to a different business.

In one embodiment, the repository is preferably a structured or an unstructured database. Preferably structured databases are advantageously used with entities words, characters or objects, where the objects may be data objects, images etc.

The accompanying figures and this description depicted and described embodiments of the present invention, and features and components thereof. Those skilled in the art will appreciate that any particular program nomenclature used in this description was merely for convenience, and thus the invention should not be limited to use solely in any specific application identified and/or implied by such nomenclature. Therefore, it is desired that the embodiments described herein be considered in all respects as illustrative, not restrictive, and that reference be made to the appended claims for determining the scope of the invention.

While particular embodiments of the present invention have been shown and described, it will be obvious to those skilled in the art that, based upon the teachings herein, that changes and modifications may be made without departing from this invention and its broader aspects. Although the invention has been described with reference to the embodiments described above, it will be evident that other embodiments may be alternatively used to achieve the same object. The scope of the invention is not limited to the embodiments described above, but can also be applied to software programs and computer program products in general. It should be noted that the above-mentioned embodiments illustrate rather than limit the invention and that those skilled in the art will be able to design alternative embodiments without departing from the scope of the appended claims. In the claims, any reference signs should not limit the scope of the claim. The invention can be implemented by means of hardware comprising several distinct elements. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method for assisting call center agents in real-time, the method comprising
receiving as input an unstructured voice signal from a caller;
transcribing the unstructured voice signal into readable text data;
identifying keywords in the readable text data;
determining a context for the voice signal based on the identified keywords;
identifying and extracting matching entities with the context from a data store; and
presenting the extracted entities to the call center agent.

2. The method of claims 1, all the limitations of which are incorporated herein by reference, wherein transcribing unstructured voice signal further comprises
segmenting the unstructured voice signal into a sequence of terms or keywords; and
retaining only terms or keywords that are relevant to the context by filtering unwanted terms or keywords.

3. The method of claim 1, all the limitations of which are incorporated herein by reference, wherein the data store is a repository.

4. The method of claim 3, all the limitations of which are incorporated herein by reference, wherein the repository is a structured or an unstructured database.

5. The method of claim 1, all the limitations of which are incorporated herein by reference, further comprising:
forming new queries based on the entities; and
suggesting the new queries to the call center agent to be provided as response to the caller.

6. The method of claim 5, all the limitations of which are incorporated herein by reference, further comprising:
refining the extracted context of the conversation based on the entity presented to the call center agent.

7. The method of claim 1, all the limitations of which are incorporated herein by reference, wherein the entities include information selected from a group consisting of relational data, tabular data, audio/video data, and graphical data.

8. A system for guiding a call center agent in real-time conversation between the call center agent and a caller to the call center, the call center agent coupled to the caller over a network, the system comprising:
receiving means for receiving and recognizing an unstructured voice signal of the caller;
transcribing means for transcribing the unstructured voice signal into readable text data;
processing means for identifying keywords in the readable text data and determining a context for the voice signal based on the identified keywords; the processing means further configured for identifying and extracting matching entities with the context from a data store; and
presenting means for presenting the extracted entities to the call center agent.

9. The system of claims 8, all the limitations of which are incorporated herein by reference, wherein the transcribing means is configured to segment the unstructured voice signal into a sequence of terms or keywords, and retain only terms or keywords that are relevant to the context by filtering unwanted terms or keywords.

10. The system of claim 8, all the limitations of which are incorporated herein by reference, wherein the data store is a repository.

11. The system of claim 10, all the limitations of which are incorporated herein by reference, wherein the repository is a structured or an unstructured database.

12. The system of claim 8, all the limitations of which are incorporated herein by reference, wherein the processing means is further configured to form new queries based on the extracted entities, and suggest the new queries to the call center agent which are provided as response to the caller.

13. The system of claim 12, all the limitations of which are incorporated herein by reference, wherein the extracted context of the conversation is refined based on the entity presented to the call center agent.

14. The system of claim 8, all the limitations of which are incorporated herein by reference, wherein the entities include information selected from a group consisting of relational data, tabular data, audio/video data, and graphical data.

15. The system of claim 8, all the limitations of which are incorporated herein by reference, wherein the transcribing means is an automated speech recognition component.

16. The system of claim 8, all the limitations of which are incorporated herein by reference, wherein receiving means, transcribing means, processing means and presenting means are components of a server, the call center agents are coupled to the server via a switch and the server configured to route the call of the caller to the call center agent.

17. A computer program product comprising a computer program instructions stored on a computer-readable storage medium, which when executing on a computer system are configured to perform the steps of
receiving as input an unstructured voice signal from a caller;
transcribing the unstructured voice signal into readable text data;
identifying keywords in the readable text data wherein transcribing further includes
segmenting the unstructured voice signal into a sequence of terms or keywords; and
retaining only terms or keywords that are relevant to the context by filtering unwanted terms or keywords;
determining a context for the voice signal based on the identified keywords;
identifying and extracting matching entities with the context from a data store; and
presenting the extracted entities to the call center agent.

18. The computer program product of claim 17, all the limitations of which are incorporated herein by reference, wherein the data store is a repository, which is a structured or an unstructured database.

19. The computer program product of claim 17, all the limitations of which are incorporated herein by reference, wherein said steps further comprise:
forming new queries based on the entities;
suggesting the new queries to the call center agent to be provided as response to the caller; and
refining the extracted context of the conversation based on the entity presented to the call center agent.

20. The computer program product comprising a data signal which includes the unstructured voice signal from a caller is transmitted over a network and received at a call center is configured to perform the steps of:
receiving as input an unstructured voice signal from a caller;
transcribing the unstructured voice signal into readable text data;
identifying keywords in the readable text data wherein transcribing further includes
segmenting the unstructured voice signal into a sequence of terms or keywords; and
retaining only terms or keywords that are relevant to the context by filtering unwanted terms or keywords;
determining a context for the voice signal based on the identified keywords;
identifying and extracting matching entities with the context from a data store; and
presenting the extracted entities to the call center agent.
